(19) United States
(12) Patent Application Publication
(10) Pub. No.: US 2005/0117336 A1
(43) Pub. Date: Jun. 2, 2005

(54) Line illumination

(76) Inventor: Reinhard Jenny, Ennetbaden (CH)

Correspondence Address: NATH & ASSOCIATES, 1030 15th STREET, NW, 6TH FLOOR, WASHINGTON, DC, 20005, US

(21) Appl. No.: 10/501,217

(22) PCT Filed: Jan. 15, 2003
(86) PCT No.: PCT/CH03/00019

(30) Foreign Application Priority Data
Jan. 15, 2002 (CH) 52/02

(51) Int. Cl. F21S 2/00

(52) U.S. Cl. 362/232

(57) ABSTRACT

The invention relates to an illuminating device comprising a light source (1, 9), disposed along a line, for illuminating a line surface (3), and at least one linear optical element (2, 10). In order to compensate for the vignetting produced by the optical element (2, 10), a diaphragm (6) is provided that produces a numerical aperture that is variable in the direction of the line.

The present invention relates to a device for illuminating a line surface according to the preamble of claim 1.

Such illuminating devices are used in reading apparatuses, that is in scanners or optical identification devices, for example in inspection stations for the industrial manufacture of products or identification devices for reading bank notes, bar codes etc.

These illuminating devices all comprise a light source disposed along a line, which light source can be a fiber-optical light source, a tube lamp or a row of electro-optical elements or LED's. In order to guide the emitted light towards a line surface to be illuminated, spherical or aspherical rod-shaped lenses or self-focussing lens arrays are used. Also known are illumination devices having parabolic or elliptically formed reflectors for guiding the light onto the line surface to be illuminated.

The use of rod-shaped lenses made of glass or synthetic material as well as the use of reflectors results in image errors, especially aperture errors and astigmatism which, in turn, influences the intensity distribution on the illuminated line surface. In particular the intensity in the region of the edges decreases. This decrease in brightness is particularly noticeable/pronounced/evident at the ends of lines.

It is therefore the aim of the present invention to correct the decrease in brightness at the ends of lines and to obtain a homogenous distribution of intensity along the entire illuminated line.

This aim is solved by the present invention in that a device for illuminating a line is provided which has the features of claim 1. In particular, this device comprises at least one element acting as a diaphragm which effects a variable numerical aperture in the direction of the line. This variable numerical aperture is designed in such a manner that the vignetting produced by an imaging lens and the natural decrease in light intensity associated therewith according to E(w)* cos⁴(w) is corrected. It is to be understood that the expert may vary the geometrical shape of the diaphragm as required. With respect to the longitudinal middle axis of the line surface this variation can be either symmetrical or asymmetrical. A suitable mechanical arrangement allows to slidably insert the diaphragms on both sides symmetrically or asymmetrically into the beam path. It is to be understood that just one diaphragm may be inserted from the side. Non-transmissive, transmissive or latticed materials may be used as diaphragm. For this it is possible to also use transmissive phase objects or structured filters etc. It is further possible to use two diaphragms having different spectral transmission values, in order to obtain a specific color combination. These diaphragms have been shown to be especially advantageous when using opto-electrical or fiber-optical line illuminators.

The invention shall be more closely described in the following exemplary embodiment and with the aid of the Figures.

FIG. 1 shows a device according to the invention with a reflector for illuminating a line surface;

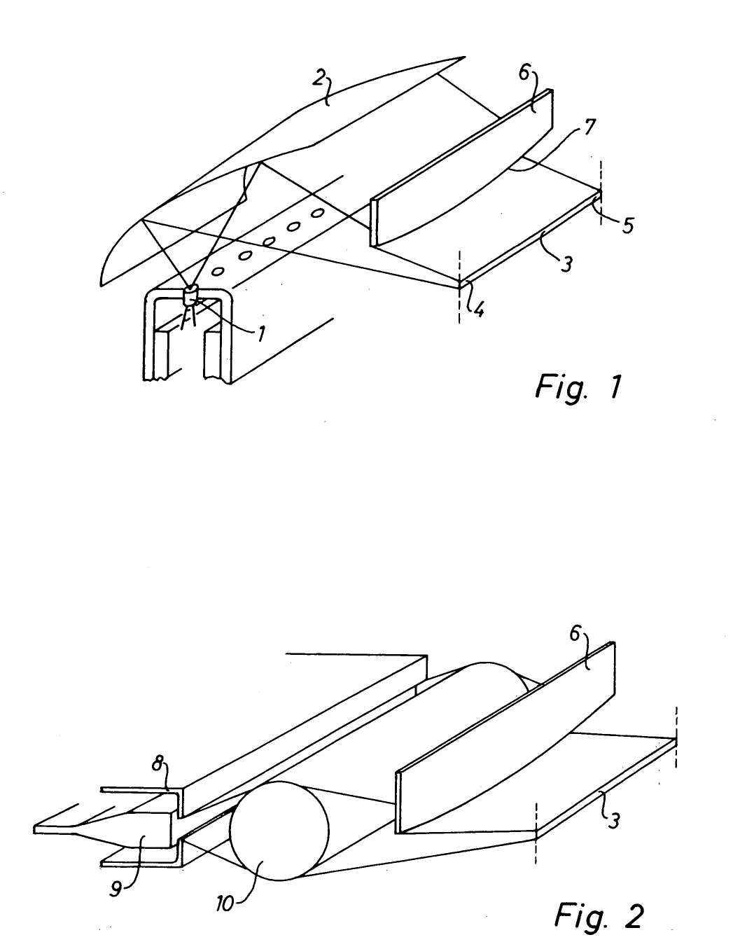

FIG. 2 shows a device according to the invention with a rod-shaped lens for illuminating a line surface;

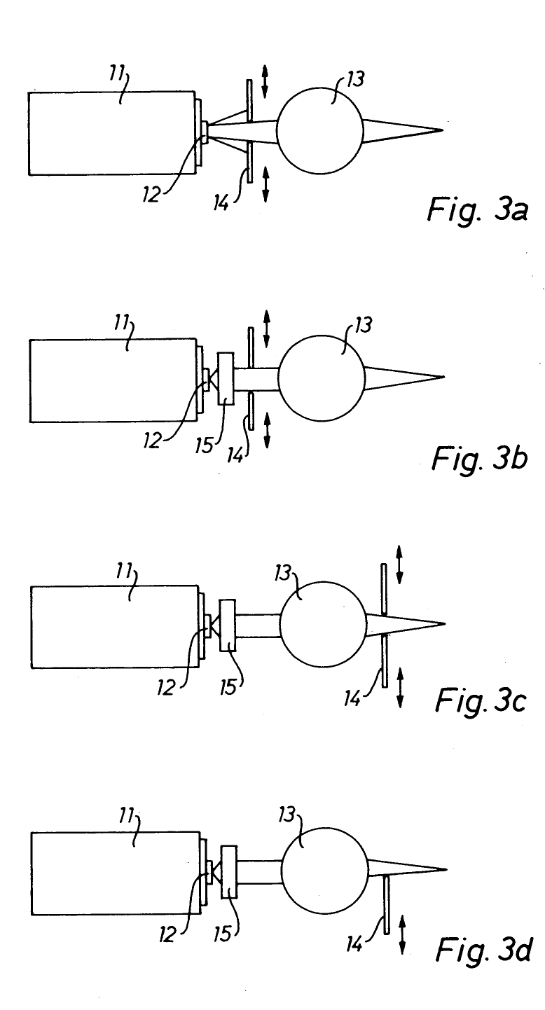

FIGS. 3a-3d show schematic illustrations of a number of illumination devices according to the invention; and

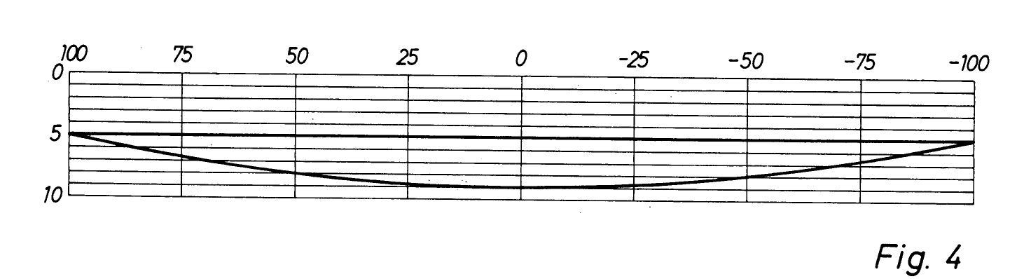

FIG. 4 shows a diaphragm shaped according to the invention for use in an illumination device.

The illumination device shown in FIG. 1 comprises several LED's 1 arranged in a row, whose light is guided by a suitably formed (spherical, parabolic, elliptical) reflector 2 to the line surface 3 to be illuminated. When the line is projected or imaged by means of a lens onto a camera sensor, the line ends are imaged less intensely than the line center (vignetting). The larger the field of view, the more pronounced is this effect. In order to better compensate these differences in brightness, the illuminating device comprises a diaphragm 6 which effects a variable numerical aperture in the longitudinal direction by means of its curved edge or rim 7. The illuminated line surface 3 generally has a length of 300 mm and a width of a few millimeters (e.g. 2-6 mm). It is understood that the dimensions of this line surface 3 is dependent upon its use. When using opto-electronic light sources it is necessary to provide cooling means in their vicinity. As an alternative to the suggested arrangement, the intensity of light of the individual LED's at the line's end may be increased when using opto-electronic light sources, in order to compensate the loss in intensity on the line surface. However, this may shorten the lifetime of these LED's. It has therefore also been suggested to vary the spacing of the individual LED's in an illumination row in such a manner that the LED's are more closely spaced at the end regions of the illumination row than in its center. Unfortunately this leads to an inhomogeneousness of light dispersion in the central region of the line surface. Similar or analogue considerations must be taken into account when using a fiber-optical line illumination.

A flat fiber optic 9 arranged in a casing 8 is used as a light source in the illuminating device shown in FIG. 2. The light diffused by the fiber optic 9 is projected on to a rod-shaped lens 10 which can have a spherical or aspherical profile. In order to better compensate the differences in light intensity described above during the projection, the illustrated illuminating device comprises a diaphragm 6 which can be inserted into the illumination path. It is to be understood that this diaphragm may also be arranged between the rod-shaped lens 10 and the fiber optic 9, or that two diaphragms 6 which are displaceable in opposing directions can be used in order to effect a slit which is variable in its longitudinal width. By using such a pair of diaphragms it is possible to change the variation of the width gradient of the slitin a simple manner by using differently shaped diaphragms. In the same manner, it is possible to use this rod-shaped lens concept also for electro-optical diffusion elements (LED's, laser diodes etc.).

The schematically shown arrangement of the illuminating device according to the invention in FIG. 3a comprises a casing 11 which encases the desired light source 12 and a possibly required electronic switch. The illumination path of the light emitted by the light source 12 or the illumination row is cut off in front of a lens element 13 by means of a diaphragm arrangement 14 according to the invention. The embodiment as shown schematically may be manufactured and mechanically realized in a very simple manner.

FIG. 3b shows a further development of the arrangement according to FIG. 3a, in which the diaphragm arrangement 14 is arranged between the lens element 13 and a further optical element 15. This additional optical element 15 can be a collimating lens, a filter or a polarizing element. Here also the diaphragm arrangement 14 is either symmetrical or asymmetrical, i.e. is either a pair or a single diaphragm.

In the device shown in FIG. 3c the diaphragm arrangement 14 is provided on the side of the lens element 13 facing towards the line surface and can also be moved in symmetrically opposing directions.

The embodiment as shown in FIG. 3d again comprises a casing 11 for encasing the light source 12 as well as an optical element 15 disposed between this light source 12 and the lens element 13. Only one diaphragm element 14 is provided in this embodiment. In this embodiment, if a collimator is used, the use of an optical lens 13 can be dispensed with.

FIG. 4 shows the shape of a diaphragm edge which takes the cos⁴-effect into account. It is clear that when using two oppositely displaceable diaphragms this edge would run differently.

Other arrangements of the diaphragm 14 are within the scope of the expert. The expert will select the shape of the edge of the diaphragm 14 according to the desired numerical aperture.

The advantages of the present illumination device are immediately evident to the expert and are to be seen in particular in the simplicity of the technical solution. With the present arrangement it is possible to evenly design the operating parameters (and the lifetime) of the LED's used, because these do not have to be operated at differing capacities (luminosity). The inhomogeneousness of the luminosity distribution in a line surface caused by LED's which are differently spaced from each other can be avoided by the use of an arrangement according to the present invention.

1. Device for illuminating a line surface (3) having a light source (1, 9) designed linearly or being linearly arranged and having at least one linearly formed optical element (2, 10), wherein in the region of said optical elements (2, 10) of said light source (1, 9) said device comprises at least one diaphragm (6) which effects a variable numerical aperture in the direction of the line.

2. Device according to claim 1, wherein the variable numerical aperture is designed in such a manner that the vignetting (decrease in light intensity at the periphery), which occurs when imaging a line by means of a lens, is compensated according to E(w)=E* cos⁴(w) or another dependency.

3. Device according to claim 2, wherein the diaphragm (6, 14) is made of a non-transmissive material.

4. Device according to claim 2, wherein the diaphragm (6, 14) is made of a spectral transmissive material.

5. Device according to claim 2, wherein the diaphragm (6, 14) is made of a material having spectral transmissive/non-transmissive patterns.

6. Device according to claim 2, wherein the diaphragm (6, 14) is made of a phase shifting structured material.
